(19) United States
(12) Patent Application Publication
(10) Pub. No.: US 2017/0299036 A1
(43) Pub. Date: Oct. 19, 2017

(54) VEHICLE DIFFERENTIAL ASSEMBLY

(71) Applicant: GM Global Technology Operations LLC, Detroit, MI (US)

(72) Inventors: Shaun X. Zhao, Novi, MI (US); Michael J. Palecek, Grand Blanc, MI (US); Dan M. Bouman, Clinton Township, MI (US)

(21) Appl. No.: 15/099,142

(22) Filed: Apr. 14, 2016

(51) Int. Cl. F16H 48/22; F16H 48/08

(52) U.S. Cl. CPC F16H 48/22; F16H 48/08

(57) ABSTRACT

A vehicle differential assembly is provided. The vehicle differential assembly includes a differential housing and a differential case rotationally coupled to the differential housing about a first axis. At least one spider gear is coupled to the differential case, the at least one spider gear arranged to rotate about a second axis, the second axis being perpendicular to the first axis. A first side gear is rotationally coupled to the at least one spider gear. A first axle is coupled to first side gear by a first spline, the first side gear being axially movable along the first spline. A first disk assembly is coupled between the first axle and the differential case, the first disk assembly being configured to selectively couple the first axle to the differential case in response to a high torque condition.

### FIELD OF THE INVENTION

The subject invention relates to a vehicle differential assembly, and more particularly, to a differential assembly configured to selectively lock in response to a low friction condition in one wheel.

### BACKGROUND

Vehicles, such as automobiles and trucks for example, include a differential and axle assembly, sometimes colloquially referred to as a drive module. This assembly is connected to the vehicle engine by a prop-shaft. The prop-shaft transmits rotational energy (torque) developed by the vehicle engine to the differential and axle assembly, which in turn transmits the rotational energy to the drive wheels. In a rear-wheel drive vehicle, the prop-shaft directly couples the differential and axle assembly to the vehicle's transmission. In an all-wheel or four-wheel drive vehicle, additional components may also be included, such as a power take-off unit for example.

One type of differential assembly is referred to as an open differential. In an open differential, the differential assembly receives torque from a prop-shaft and transfers it to the axles. When the vehicle is driving straight, the axles rotate in unison. When the vehicle is turning or driving on a curved road, the differential bifurcates the torque differently between the wheel closer to the inside of the curve and the wheel closer to the outside of the curve. In this way, the vehicle can complete the turn without wheel slippage as the wheel along the inner side of the curve travels a shorter distance relative to the outer wheel.

Open differential assemblies perform well in splitting the torque between the wheels. They are also light weight, inexpensive and have few maintenance requirements. However, since the torque from the engine follows the path of least resistance, one situation where the open differential performance is reduced is when one of the two wheels is positioned on a slippery surface. In this situation, the open differential transfers the same torque to the wheel on the slippery surface as the opposite wheel. As a result, the vehicle may have difficulty moving from the location. To improve performance, another type of differential is used, referred to as a limited-slip differential, is used. One type of limited-slip differential utilizes a pack of friction plates between the differential case and a differential side gear. In this type of differential, when one of the wheels is on a slippery surface, the differential engages the friction plates to transfer additional torque to the opposite wheel. Due to space constraints, the friction plates have a small friction surface that may create reliability issues and increased cost.

Accordingly, it is desirable to provide a limited-slip differential and axle assembly having improved performance and lower cost.

### SUMMARY OF THE INVENTION

In one exemplary embodiment of the invention, a vehicle differential assembly is provided. The vehicle differential assembly includes a differential housing and a differential case rotationally coupled to the differential housing about a first axis. At least one spider gear is coupled to the differential case, the at least one spider gear arranged to rotate about a second axis, the second axis being perpendicular to the first axis. A first side gear is rotationally coupled to the at least one spider gear. A first axle is coupled to first side gear by a first spline, the first side gear being axially movable along the first spline. A first disk assembly is coupled between the first axle and the differential case, the first disk assembly being configured to selectively couple the first axle to the differential case in response to a high torque condition.

In another exemplary embodiment of the invention, a method of selectively transmitting torque with a vehicle differential assembly is provided. The method includes rotating a differential case about a first axis. At least one spider gear is rotated with the differential case, the at least one spider gear being coupled to rotate about second axis, the second axis being perpendicular to the first axis. A first side gear is rotated about the first axis with the at least one spider gear, the first side gear being movably coupled to a first axle. The first axle is selectively coupled to the differential case with a first set of disks and a second set of disks in response to a high torque condition.

In another exemplary embodiment of the invention, a vehicle is provided. The vehicle including an engine configured to transmit torque. A differential housing is provided having a pinion, the pinion being operably coupled to receive torque from the engine. A differential case is rotationally coupled to the differential housing about a first axis. At least one spider gear is coupled to the differential case, the at least one spider gear arranged to rotate about a second axis, the second axis being perpendicular to the first axis. A first side gear is rotationally coupled to the at least one spider gear. A first axle is coupled to first side gear by a first spline, the first side gear being axially movable along the first spline. A first disk assembly is coupled between the first axle and the differential case, the first disk assembly being configured to selectively couple the first axle to the differential case in response to a high torque condition.

The above features and advantages and other features and advantages of the invention are readily apparent from the following detailed description of the invention when taken in connection with the accompanying drawings.

### BRIEF DESCRIPTION OF THE DRAWINGS

Other features, advantages and details appear, by way of example only, in the following detailed description of embodiments, the detailed description referring to the drawings in which:

FIG. 1 is a top schematic view of a vehicle having a differential housing and axle assembly in accordance with an embodiment of the invention;

FIG. 2 is a partial sectional view of a differential assembly in accordance with an embodiment of the invention; and

FIG. 3 is an enlarged view of a portion of the differential assembly of FIG. 2.

### DESCRIPTION OF THE EMBODIMENTS

The following description is merely exemplary in nature and is not intended to limit the present disclosure, its application or uses. It should be understood that throughout the drawings, corresponding reference numerals indicate like or corresponding parts and features.

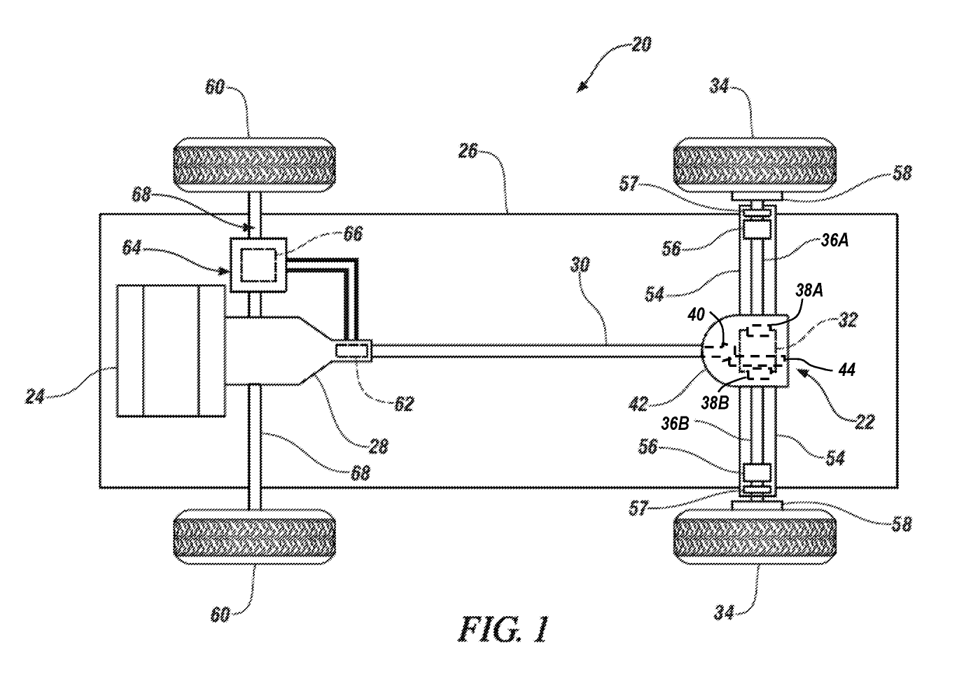

In accordance with an embodiment of the invention, FIG. 1 illustrates a vehicle 20 having a differential assembly 22. The differential assembly 22 may sometimes be referred to as a rear drive module. It should be appreciated that the vehicle 20 may be an automobile, truck, van or sport utility vehicle for example. As used herein, the term vehicle is not limited to just an automobile, truck, van or sport utility vehicle, but may also include any self-propelled or towed conveyance suitable for transporting a burden. The vehicle 20 may include an engine 24, such as a gasoline or diesel fueled internal combustion engine for example. The engine 24 may further be a hybrid type engine that combines an internal combustion engine with an electric motor for example. The engine 24 and differential assembly 22 are coupled to a frame or other chassis structure 26. The engine 24 is coupled to the rear differential assembly 22 by a transmission 28 and a prop-shaft 30. The transmission 28 may be configured to reduce the rotational velocity and increase the torque of the engine output. This modified output is then transmitted to the differential assembly 22 via the prop-shaft 30. The rear differential assembly 22 transmits the output torque from the prop-shaft 30 through a differential gear set 32 to a pair of driving-wheels 34 via axles 36A, 36B.

The differential gear set 32 is arranged within a differential housing 42. The differential gear set 32 receives the output from the prop-shaft 30 via a pinion 40 that transmits the torque to a ring gear 44. The differential gear set 32 is supported for rotation within the housing 42 by a pair of differential bearings. The differential gear set 32 includes side gears 38A, 38B arranged within the housing 42 that are coupled to and support one end of the axles 36A, 36B. As will be discussed in more detail herein, the side gears 38A, 38B are coupled to the ring gear 44 by spider gears and a differential case. The coupling of rotational components, such as the pinion 40 or the side gears 38A, 38B to the axles 36A, 36B for example, may be accomplished using a spline connection.

In one embodiment, each axle 36A, 36B extends through an axle tube 54. The axle tube 54 includes a hollow interior that extends the length thereof. At one end of the axle tube 54 a bearing 56 is mounted to support the end of the axle 36 adjacent the driven-wheel 34. A shaft seal 57 is located between the bearing 56 and the driven-wheel 34. A wheel mounting flange 58 is coupled to the end of the axle 36 adjacent the bearing 56. The flange 58 provides an interface for mounting of the driven-wheel 34.

The vehicle 20 further includes a second set of wheels 60 arranged adjacent the engine 24. In one embodiment, the second set of wheels 60 is also configured to receive output from the engine 24. This is sometimes referred to as a four-wheel or an all-wheel drive configuration. In this embodiment, the vehicle 20 may include a transfer case 62 that divides the output from the transmission 28 between the front and rear driven wheels 34, 60. The transfer case 62 transmits a portion of the output to a front differential assembly 64, which may include additional components such as a differential gear set 66 and axles 68 that transmit the output to the wheels 60.

The front differential assembly 64 may include a disconnect arrangement that allows for selective application of torque from the engine 24 to the wheels 60. In other embodiments, the disconnect arrangement may be incorporated into the rear differential assembly 22.

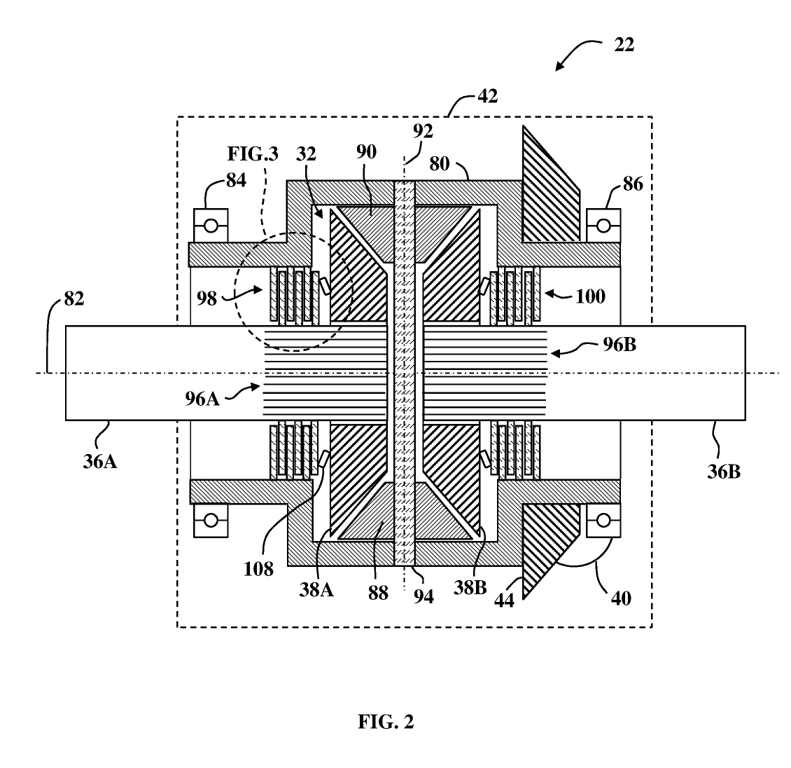

Referring now to FIG. 2, an exemplary differential assembly 22 is illustrated. It should be appreciated that while embodiments herein refer to the rear differential assembly 22, the disclosed embodiments may also be incorporated in the front differential assembly 64. The differential assembly 22 includes a housing 42 that is mounted to the vehicle frame or chassis structure 26 (FIG. 1) in one or more locations, such as by a mounting arm for example. The pinion 40 extends into the housing 42 to transfer torque from the prop-shaft 30. The pinion 40 includes a gear on one end that engages a ring gear 44. Also disposed within the housing 42 is a differential case 80 containing the differential gear set 32.

The differential case 80 is mounted for rotation to the housing 42 about axis 82, such as by bearings 84, 86 for example. The ring gear 44 is coupled to the differential case 80 such as by welding, for example. In one embodiment, the bearings 84, 86 further support the axles 36A, 36B, which are coupled to the side gears 38A, 38B of the differential gear set 32. The side gears 38A, 38B are coupled to the differential case 80 through spider gears 88, 90. The spider gears 88, 90 are coupled for rotation about an axis 92 to the differential case 80. In an embodiment, the spider gears 88, 90 are coupled to each other and the differential case 80 via a shaft 94. Therefore, the spider gears 88, 90 are arranged to rotate about both differential case axis 82 and the shaft axis 92. The spider gears 88, 90 and the side gears 38A, 38B are disposed in a meshed engagement to transfer torque from the pinion 40 through the ring gear 44 and differential case 80 to the axles 36A, 36B.

It should be appreciated that in some embodiments the differential gear set 32 may include two or more pairs of spider gears oriented 90 degrees apart for transferring torque to the side gears 38A, 38B as is known in the art.

In the exemplary embodiment, the side gears 38A, 38B are coupled to the axles 36A, 36B by splines 96A, 96B, respectively. The spines 96A, 96B couple with or to the side gears 38A, 38B to transfer torque from the side gears 38A, 38B to the axles 36A, 36B while still allowing a limited amount of lateral movement in a direction along the axis 82. As will be discussed in more detail below, under some operating circumstances, such as under high torque conditions, the spider gears 88, 90 may apply an axial side load to the respective side gear 36A, 36B in a direction away from the axis 92.

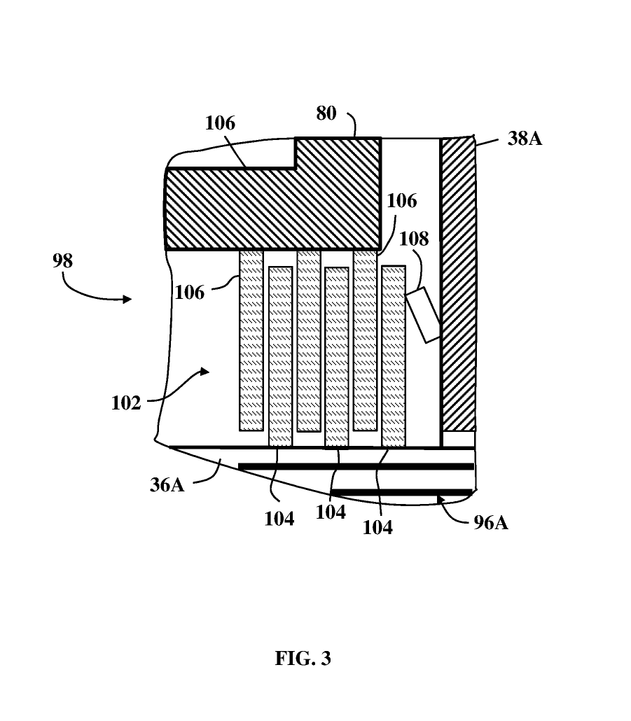

Coupled between the differential case 80 and the axles 36A, 36B are friction disk assemblies 98, 100. Referring now to FIG. 3, an enlarged view of a portion of the friction disk assembly 98 is shown. It should be appreciated that while friction disk assembly 98 is described in detail herein, the friction disk assembly 100 is constructed in a similar manner. The friction disk assembly 98 is comprised of a plurality of disks 102. The disks 102 are arranged in an alternative manner with a first set of disks 104 being coupled to the axle 36A and a second set of disks 106 being coupled to the differential case 80. In an embodiment, one of the sets of disks 104, 106 is a steel plate and the other from a high friction material. In an embodiment, the first set of disks 104 is coupled to the axles 36A, 36B by splines 96A, 96B.

Disposed between the disks 102 and the side gear 38A is a biasing member, such as a Bellville or dish washer 108. The dishwasher 108 imposes an axial force along the axis 82 that applies a preload on the friction plates. It should be appreciated that under high torque conditions, such as when the wheel 34 coupled to the axle 36A is on a low friction surface for example, the axial load from the spider gears 88, 90 on the side gear 38A may provide additional biasing force to the disks 102. As will be discussed in more detail herein, when the axial load increases to a predetermined level, the disks 104 engage the disks 106 and connect the axle 36A directly to the differential case 80.

In operation, when the vehicle is driving on a straight road, the engine torque is evenly transferred between the wheels 34; since the wheels 34 are traveling the same distance, they are also rotating at the same speed. In other words, the spider gears 88, 90 do not rotate about the axis 92 and the side gears rotate with the case as a single unit. When the vehicle is operated on a curve, the spider gears 88, 90 rotate about both the axle axis 82 and the shaft axis 92. This rotation about two axis 82, 92 causes the side gear on the inside of the curve (e.g. side gear 38B) to rotate at slower speed than the side gear on the outside of the curve (e.g. side gear 38A). In this way, the differential assembly 32 performs the same as an open differential and the vehicle may travel along a curve with the right and left wheels rotating at different speeds.

During operation, a situation may occur wherein one of the wheels 34, such as the wheel 34 coupled to the axle 36B for example, is on a low friction surface while the opposite wheel 34, such as the wheel 34 coupled to the axle 36A for example, is on a surface with higher friction. In this situation, the torque on the axle 36B is lower due to low friction between the wheel 34 and the surface, as a result the axle 36A torque will be the same as axle 36B and will be limited by the low frictional side torque. However, the frictional force between the first set of disks 104 and the second set of disks 106 (FIG. 3) may provide a threshold to ensure a predetermined amount of torque may be transferred to the wheel 34 coupled to axle 36A. Further, the spider gears 88, 90 may move along the splines 96A in a manner to apply additional frictional force between the first set of disks 104 and the second set of disks 106.

Therefore, the torque received from the pinion 40 will be transferred to the differential case 80 to the axle 36A. This provides torque to the wheel 34 connected to the axle 36A and may allow the vehicle 20 to be driven off of the low friction surface.

The limited-slip performance of the differential assembly 22 may be configured based on the intended application of the vehicle. For example, the amount of engagement between the disks and the amount of axial side load applied by the spider gear may be changed by altering the stiffness of the dish washer or the pressure angles of the spider gear and side gears. This in turn may adjust the degree to which the disks 102 engage and the amount of slippage between the disks 102 that occurs.

It should be appreciated that in some embodiments, the sets of disks 102 may be in frictional contact with each other during normal operation. In this embodiment, the first set of disks 104 will slip or rotate relative to the second set of disks 106 when the vehicle 20 moves along a curve.

It should further be appreciated that the differential assembly 32 having friction disk assemblies 98, 100, is advantageous in providing a limited slip differential with reduced contact stress relative to prior art limited slip differential assemblies. Since the friction disk assemblies are coupled between the axles 36A, 36B and the differential case 80, the smaller inner diameter for each of the disks 104, 106 provides for a larger contact surface than was provided by prior art systems where friction disks were arranged between the spider gear and the differential case. This in turn decreases the amount of unit surface loading between the sets of disks 102. As a result of the decreased surface loading, advantages are gained in reducing the amount of wear and noise, sometimes referred to as clutch chatter, generated by the differential assembly 32.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed, but that the invention will include all embodiments falling within the scope of the application.

What is claimed is:

1. A vehicle differential assembly comprising:
a differential housing;
a differential case rotationally coupled to the differential housing about a first axis;
at least one spider gear coupled to the differential case, the at least one spider gear arranged to rotate about a second axis, the second axis being perpendicular to the first axis;
a first side gear rotationally coupled to the at least one spider gear;
a first axle coupled to the first side gear by a first spline, the first side gear being axially movable along the first spline; and
a first disk assembly coupled between the first axle and the differential case, the first disk assembly being configured to selectively couple the first axle to the differential case in response to a high torque condition.

2. The vehicle differential assembly of claim 1 wherein the first disk assembly includes a first set of disks coupled to the first axle and a second set of disks coupled to the differential case, the first set of disks and the second set of disks being frictionally engaged at least in response to the high torque condition.

3. The vehicle differential assembly of claim 2 wherein the first disk assembly further includes a biasing member coupled between the first side gear and one of the first set of disks and the second set of disks.

4. The vehicle differential assembly of claim 3 wherein the biasing member is a dish washer.

5. The vehicle differential assembly of claim 3 wherein the first side gear is movable between a first position and a second position, the first disk assembly coupling the first axle to the differential case in the second position.

6. The vehicle differential assembly of claim 1 further comprising:
a second side gear rotationally coupled to the at least one spider gear opposite the first side gear;
a second axle coupled to the second side gear by a second spline, the second side gear being axially movable along the second spline; and
a second disk assembly coupled between the second axle and the differential case, the second disk assembly being configured to selectively couple the second axle to the differential case in response to the high torque condition.

7. The vehicle differential assembly of claim 6 wherein the second disk assembly including a third set of disks coupled to the second axle and a fourth set of disks coupled to the differential case, the third set of disks and the fourth set of disks being frictionally engaged at least in response to the high torque condition.

8. A method of selectively transmitting torque with a vehicle differential assembly, the method comprising:
rotating a differential case about a first axis;
rotating at least one spider gear with the differential case, the at least one spider gear being coupled to rotate about a second axis, the second axis being perpendicular to the first axis;
rotating a first side gear about the first axis with the at least one spider gear, the first side gear being movably coupled to a first axle; and
selectively coupling the first axle to the differential case with a first set of disks and a second set of disks in response to a high torque condition.

9. The method of claim 8 further comprising biasing the first side gear towards the at least one spider gear with a first biasing member coupled between the first set of disks and the first side gear.

10. The method of claim 9 wherein the first biasing member is a dish washer.

11. The method of claim 9 further comprising:
applying an axial side load to the first side gear with the at least one spider gear in response to the high torque condition; and
moving the first side gear from a first position to a second position in response to the axial side load.

12. The method of claim 9 further comprising
rotating a second side gear about the first axis with the at least one spider gear, the second side gear being movably coupled to a second axle; and
selectively coupling the second axle to the differential case with a third set of disks and a fourth set of disks in response to the high torque condition.

13. The method of claim 12 further comprising biasing the second side gear towards the at least one spider gear spider gear with a second biasing member coupled between the third set of disks and the second side gear.

14. A vehicle comprising:
an engine configured to transmit torque;
a differential housing having a pinion, the pinion being operably coupled to receive the torque from the engine;
a differential case rotationally coupled to the differential housing about a first axis;
at least one spider gear coupled to the differential case, the at least one spider gear arranged to rotate about a second axis, the second axis being perpendicular to the first axis;
a first side gear rotationally coupled to the at least one spider gear;
a first axle coupled to the first side gear by a first spline, the first side gear being axially movable along the first spline; and
a first disk assembly coupled between the first axle and the differential case, the first disk assembly being configured to selectively couple the first axle to the differential case in response to a high torque condition.

15. The vehicle of claim 14 wherein the first disk assembly includes a first set of disks coupled to the first axle and a second set of disks coupled to the differential case, the first set of disks and the second set of disks being frictionally engaged at least in response to the high torque condition.

16. The vehicle of claim 15 wherein the first disk assembly further includes a biasing member coupled between the first side gear and one of the first set of disks and the second set of disks.

17. The vehicle of claim 16 wherein the biasing member is a dish washer.

18. The vehicle of claim 16 wherein the first side gear is movable between a first position and a second position, the first disk assembly coupling the first axle to the differential case in the second position.

19. The vehicle of claim 14 further comprising:
a second side gear rotationally coupled to the at least one spider gear opposite the first side gear;
a second axle coupled to the second side gear by a second spline, the second side gear being axially movable along the second spline; and
a second disk assembly coupled between the second axle and the differential case, the second disk assembly being configured to selectively couple the second axle to the differential case in response to the high torque condition.

20. The vehicle of claim 19 wherein the second disk assembly including a third set of disks coupled to the second axle and a fourth set of disks coupled to the differential case, the third set of disks and the fourth set of disks being frictionally engaged at least in response to the high torque condition.
